(19) United States
(12) Patent Application Publication
(10) Pub. No.: US 2004/0148929 A1
(43) Pub. Date: Aug. 5, 2004

(54) Master cylinder device with booster device

(76) Inventors: Katsuhiro Mita, Gamagouri-shi (JP); Tomoo Ogura, Aichi-ken (JP)

Correspondence Address: BURNS DOANE SWECKER & MATHIS L L P, POST OFFICE BOX 1404, ALEXANDRIA, VA, 22313-1404, US

(21) Appl. No.: 10/743,794

(22) Filed: Dec. 24, 2003

(30) Foreign Application Priority Data
Jan. 31, 2003 (JP) 2003-23130

(51) Int. Cl. B60T 8/44

(52) U.S. Cl. 60/547.1

(57) ABSTRACT

A master cylinder device with a brake booster device of an input rod pulling type is provided which is easy to assemble and in which the brake booster device and the master cylinder device therefor can be assembled independently of each other. The brake booster device is constructed so that a booster is partitioned by a diaphragm into a constant pressure chamber and a variable pressure chamber and that a piston secured to the diaphragm incorporates therein a valve mechanism for changing over the variable pressure chamber into communication with the constant pressure chamber or into communication with the atmosphere. The master cylinder device is constructed so that a master piston is inserted in a master cylinder formed in a cylinder body and that the pressurized brake fluid is delivered when a piston rod connected to the master piston is pulled toward the passenger room of the vehicle. The brake booster device is connected with the master cylinder device by bringing a front shell of the booster into abutting engagement with the rear end surface of the cylinder body, and the output rod of the brake booster device is connected by a joint means with the piston rod of the master cylinder device.

### INCORPORATION BY REFERENCE

This application is based on and claims priority under 35 U.S.C. sctn. 119 with respect to Japanese Application No. 2003-23130 filed on Jan. 31, 2003, the entire content of which is incorporated herein by reference.

### BACKGROUND OF THE INVENTION

1. Field of the Invention

The present invention relates to a master cylinder device with a booster device and more particularly, to a master cylinder device of the type that generates pressurized brake fluid by pulling an input rod of the booster device.

2. Discussion of the Related Art

Heretofore, as described in Japanese unexamined, published patent application No. 2001-294138, there has been known a master cylinder device with a booster device of the type that generates pressurized brake fluid by pulling an input rod of the booster device in order to prevent a brake pedal from jumping up toward the driver at the time of vehicle collision. In the known master cylinder device, a brake booster device is installed on one surface facing an engine room of a dashboard which partitions the engine room from a passenger room. The booster device is connected with a master cylinder device having a master cylinder, and a first master piston is inserted into a forward end portion of the master cylinder. A second master piston is inserted into a rear end portion spaced from the first master piston of the master cylinder. A piston rod connected to the first master piston passes through the second master piston and is protruded from the rear end wall of the master cylinder to be operated by a brake booster device. A brake pedal arm is pivotably carried at its mid portion on a pedal bracket, which is secured to the other surface facing the passenger room of the dashboard. The brake pedal pivotably carries at its upper end a pull or input rod connected to a valve mechanism of the brake booster device and is provided with a pedal step plate at its lower end.

In the aforementioned master cylinder device with a brake booster device of the input rod pulling type, if an output rod of the brake booster device and the piston rod of the master cylinder device are provided as independent members, they would be hidden in the devices when brought into connection, and it would become difficult to connect the output rod of the brake booster device with the piston rod of the master cylinder. Thus, it is presumed that in the aforementioned brake booster device, the output rod and the piston rod are made bodily as a single member. However, if the output rod and the piston rod are made bodily as a single member, neither the brake booster device nor the master cylinder device can be assembled independently of each other, and thus, a problem arises in that the assembling of these devices becomes difficult. Another drawback also arises in that the swing or tilting motion of the output rod of the brake booster device causes the first master piston of the master cylinder to scrape against the master cylinder, so that the master piston cannot slide smoothly thereby to increase the sliding resistance.

### SUMMARY OF THE INVENTION

Accordingly, it is a primary object of the present invention to provide an improved master cylinder device with a booster device of an input rod pulling type which is capable of enabling a master cylinder device and a booster device to be assembled independently of each other thereby to be easy to assemble.

Briefly, according to the present invention, there is provided a master cylinder device with a booster device connected therewith. The booster device is constructed so that a diaphragm is put between a front shell and a rear shell to define a constant pressure chamber and a variable pressure chamber and that a piston connected to the diaphragm incorporates therein a valve mechanism for changing over the variable pressure chamber into communication with the constant pressure chamber or into communication with the atmosphere, and a reaction mechanism for transmitting the movement of the piston to an output rod through a reaction member and for feeding the movement of the piston back to said valve mechanism. The brake booster device is further constructed so that when the input rod is moved by a brake pedal toward a passenger room, the valve mechanism leads the variable pressure chamber to the atmosphere thereby to retract the piston together with the diaphragm. The master cylinder device is constructed so that a master piston is inserted in a master cylinder formed in a cylinder body and that the master cylinder delivers pressurized brake fluid when the piston rod connected to the master piston is pulled toward the passenger room. The booster device and the master cylinder device are connected by bringing the front shell into abutting engagement with the rear end surface of the cylinder body, and the output rod of the booster device and the piston rod of the master cylinder device are connected by a joint means with each other.

With this configuration, when the brake pedal is manipulated to pull the input rod toward the passenger room, the valve mechanism is brought into operation which is incorporated in the piston attached to the diaphragm of the booster device. The operation of the valve mechanism causes the variable chamber to be led to the atmosphere, whereby the pressure difference between the constant and variable pressure chambers occurs to operate the diaphragm thereby to retract the piston. The retraction movement of the piston is transmitted to the output rod through the reaction mechanism and is fed back to the valve mechanism. When the piston rod connected to the master piston of the master cylinder device is pulled by the output rod toward the passenger room, pressurized operating fluid is delivered from the master cylinder. Since the booster device is connected with the master cylinder device by bringing the front shell into abutting engagement with the rear end surface of the cylinder body, and since the output rod of the booster device is connected by the joint means with the piston rod of the master cylinder, it can be realized to assemble the booster device and the master cylinder device independently of each other. Therefore, there can be provided the master cylinder device with the booster device of the input rod pulling type which is easy to assemble and inexpensive to manufacture.

### BRIEF DESCRIPTION OF THE ACCOMPANYING DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a longitudinal sectional view of a master cylinder device with a booster device of an input rod pulling type in the first embodiment according to the present invention;

FIG. 2 is a side view partly in section of another master cylinder device with a booster device of an input rod pulling type in the second embodiment according to the present invention; and

FIGS. 3(A)-3(E) are explanatory views showing other embodiments or modified forms of joint means for connecting an output rod of the booster device with a piston rod of the master cylinder device.

### DETAILED DESCRIPTION OF THE PREFERRED EMBODIMENTS

(First Embodiment)

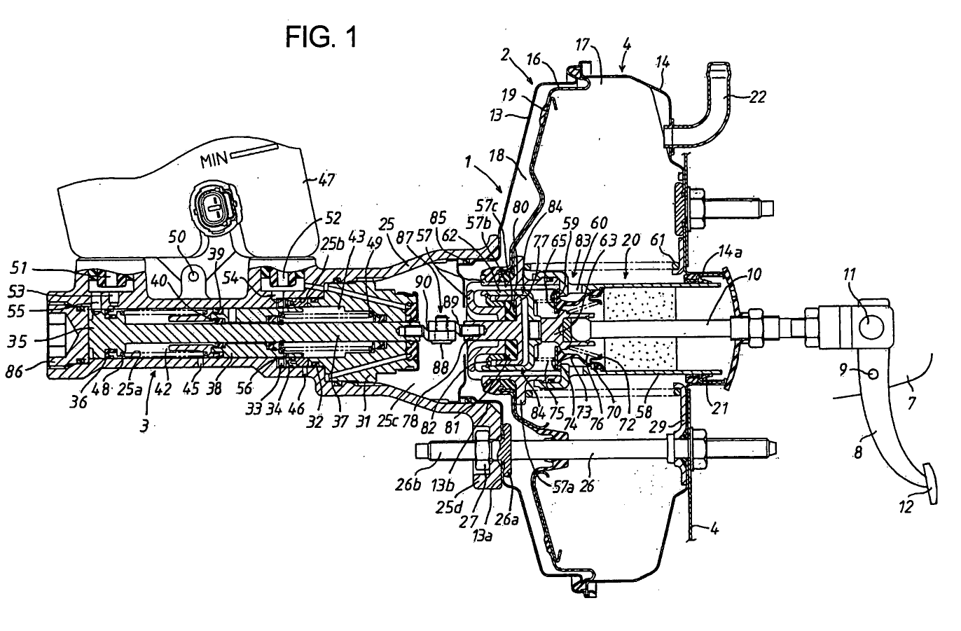

A master cylinder device with a booster device in the first embodiment according to the present invention will be described hereinafter with reference to the accompanying drawings. Referring now to FIG. 1, a numeral 1 generally denotes a master cylinder device with a booster device of an input rod pulling type which is constituted by connecting a booster device 2 with a master cylinder device 3. The master cylinder device with the booster device generally indicated by numeral 1 is fixed to a dashboard (i.e., a partition wall) 4 of a vehicle which separates or compartments a passenger room from an engine room in a motor vehicle. Provided fixedly on the dashboard 4 within the passenger room (i.e., on a surface facing the passenger room of the dashboard 4) is a pedal bracket 7, on which a brake pedal arm 8 is pivotably carried by means of a pivot pin 9 at its middle portion. The brake pedal arm 8 pivotally carries an input rod 10 by means of a connecting pin 11 at its upper end and is provided with a brake pedal 12 at its lower end.

The booster device 2 has a front shell 13 and a rear shell 14 which constitutes a booster 4 together. The circumferential portions of these shells 13, 14 put the circumferential edge bead portion of a diaphragm 16 therebetween to secure the bead portion air-tightly and are secured by caulking to each other at several portions in the circumferential direction thereof. Thus, the interior of the booster 4 is partitioned with the diaphragm 16 into a constant pressure chamber 17 and a variable pressure chamber 18. An annular plate 19 is laminated on the diaphragm 16 within the constant pressure chamber 17. A piston 20 is inserted at its forward end into center holes of the diaphragm 16 and the annular plate 19 and has the same secured air-tightly to the circumferential surface of its forward end portion. Thus, the forward end portion of the piston 20 is exposed to the variable pressure chamber 18. The rear shell 14 is formed, at the center portion of its rear surface with a cylindrical protruding portion 14a, which projects rearward to pass through an opening formed on the dashboard 4, and the end of the cylindrical protruding portion 14a opens to the passenger room. The protruding portion 14a axially slidably supports the rear end external portion of the piston 20 by the used of a seal element 21 thereby to isolate the constant pressure chamber 17 from the atmosphere. The rear shell 14 is provided with a negative-pressure leading conduit 22 connected therewith. The constant pressure chamber 17 is made in communication with an intake manifold (not shown) through the negative-pressure leading conduit 22, so that the chamber 17 is kept at a negative pressure.

The piston 20 is composed of a first piston portion 57 fixedly inserted into the center hole of the diaphragm 16 and a second piston portion 58 slidably supported by the rear shell 14. The forward end of the second piston portion 58 is fit on the rear end external surface of the first piston portion 57 and is connected bodily therewith by caulking. At the connecting portion of the second piston portion 58 with the first piston portion 57, there is formed a protruding portion which extend circumferentially and radially inwardly. A first valve seat 59 is formed at the end surface of the protruding portion facing the first piston portion 57. Further, close to the connecting portion of the second piston portion 58 with the first piston portion 57, there are provided radially extending holes 60 at plural portions in the circumferential direction. A part inside the second piston portion 58 is in communication with the constant pressure chamber 17 by way of the radially extending holes 60.

A flange portion 57a is formed on the circumference of the axial mid portion of the first piston portion 57. A return spring 61 is interposed between the flange portion 57a and a spring seat 29 abutting on the rear shell 14 thereby to urge the piston 20 forwardly. A cup-shape connecting member 62 is slidably inserted into the internal surface of the first piston portion 57. Communication grooves 57b are axially formed on the insertion surface, i.e., the internal surface of the first piston portion 57, which inserts the connecting member 62 thereinto, and open to the variable pressure chamber 18. An atmospheric valve member 63 is connected to the center of the rear surface of the connecting member 62. The atmospheric valve member 63 passes through the connecting portion of the both piston portions 57, 58 and extends into the second piston portion 58 to be connected with the forward end of the input rod 10.

The atmospheric valve member 63 is formed at its circumference with a flange or protruding portion which protrudes radially outwardly. A second valve seat 65 is formed on the protruding portion to face the first piston portion 57. Thus, the first valve seat 59 formed on the second piston portion 58 and the second valve seat 65 formed on the atmospheric valve member 63 are radially spaced apart from each other with a clearance therebetween and are in correspondence to each other in their axial positions.

A reference numeral 70 denotes a tubular control valve member for changing over the variable pressure chamber 18 into the communication with the atmosphere or into the communication with the constant pressure chamber 17. The root portion of the control valve member 70 is secured by means of a metal holdfast 72 to the internal surface of the second piston portion 58. The control valve member 70 is provided with a valve portion 74, which is connected to the root portion through a flexible portion 73 stretchable in the axial direction. The valve portion 74 is plunged inside the first piston portion 57 through the clearance between the first valve seat 59 and the second valve seat 65 and is urged by the resilient force of a compression spring 75 to contact the both valve seats 59, 65. The control valve member 70 partitions the interior of the piston 20 into a constant pressure chamber side and an atmosphere side. Thus, with the control valve member 70 being in contact to the first and second valve seats 59, 65 or being in separation therefrom, either the constant pressure chamber 17 or the atmosphere is brought into communication with the variable pressure chamber 18 through the communication grooves 57b.

A cup-shape output member 77 is inserted into the connecting member 62 to be axially slidable a predetermined amount. An output member 77 protrudes an output rod 78 from its bottom surface ahead of the piston 20. An annular reaction chamber 80 is defined between the bottom surface of the output member 77 and a reaction surface 57c of the first piston 57 and contains therein an annular reaction member 81 made of an elastic material like rubber for example. An annular ring 82 is engaged with the connecting member 62 to put the reaction member 81 between itself and the bottom surface of the output member 77.

The foregoing first and second valve seats 59, 65, the control valve member 70, the compression spring 75 and the like constitute a valve mechanism 83 for changing over the variable pressure chamber 18 into communication with the constant pressure chamber 17 or into communication with the atmosphere. Further, the output member 77, the first piston portion 57, the reaction member 81 contained in the reaction chamber 80, the annular ring 82, the connecting member 62 and the like constitute a reaction mechanism 84 for transmitting the movement of the piston 20 to the output rod 78 through the reaction member 81 and for feeding such movement back to the valve mechanism 83. These valve mechanism 83 and reaction mechanism 84 are incorporated inside the piston 20.

The front shell 13 and the rear shell 14 are connected with each other with two tie rods 26, which are arranged in the circumferential direction to extend in parallel relation with the axis of the booster 4 constituted by the both shells. Each tie rod 26 air-tightly passes through the diaphragm 16 at its mid portion and is air-tightly in abutting engagement at a large-diameter mounting seat 26a thereof with the interior surface of the front shell 13 within the variable pressure chamber 18. The forward end portion of each tie rod 26 is formed as a male screw portion, on which a nut 27 is screwed to put a flange portion 25d of the cylinder body 25 therebetween, so that the master cylinder device 3 is supported by the tie rods 26. The rear end portion formed also as a male screw portion of each tie rod 26 air-tightly passes through the rear shell 14 and the dashboard 4 and, together with a nut (not numbered) screwed thereon, puts the rear shell 14 and the dashboard 4 therebetween, so that the booster device 2 is mounted on the dashboard 4.

The master cylinder device 3 is constituted by forming a cylinder body 25 with a master cylinder 25a, a fitting hole 25b and an opening hole 25c to pass therethrough in a stepped form and in coaxial alignment. First and second master pistons 35, 38 are inserted into the master cylinder 25a to be slidable therein. A plug member 31 is fit at its forward end in the fitting hole 25b formed at the mid portion, with an O-ring 32 sealing the fitting portion between the forward end and the fitting hole 25b. The plug member 31 fixedly screwed into the mid portion of the cylinder body 25 with a ring member 33 and a seal member 34 being interposed between its forward end surface and a shoulder portion of the fitting hole 25b. An internal surface of the plug member 31 is made the same diameter as that of the master cylinder 25a. The rear end portion of the plug member 31 is exposed to the opening hole 25c. A forward end opening of the master cylinder 25a is closed fluid-tightly with a cap 86 which is removably screwed therein.

The first master piston 35 is slidably inserted into the forward portion of the master cylinder 25a. A seal element 36 fit in an annular groove formed on the first master piston 35 provides a sealing between the external surface of the first master piston 35 and the internal surface of the master cylinder 25a. A piston rod 37 protruding from the rear end of the first master piston 35 passes through the plug member 31 to extend within the opening hole 25c. Within the master cylinder 25a, the second master piston 38 is slidably received between the first master piston 35 and the plug member 31. A seal element 39 fit in an annular groove formed on the second master piston 38 provides a sealing between the external surface of the second master piston 38 and the internal surface of the master cylinder 25a. The piston rod 37 passes through the second master piston 38 to be slidable relative thereto with a seal element 40 providing a sealing therebetween. Thus, the second master piston 38 fluid-tightly partitions the master cylinder 25a into a first cylinder chamber 42 and a second cylinder chamber 43. The first cylinder chamber 42 is in fluid communication with a first brake system (not shown) through a port 45, while the second cylinder chamber 43 is in fluid communication with a second brake system (not shown) through another port 46. Compression springs 48, 49 are interposed respectively between the first and second master pistons 35, 38 and between the second master piston 38 and the plug member 31, so that the second master piston 38 is kept balanced and stopped at a neutral position when not in operation.

On the top of the cylinder body 25, a reservoir 47 is mounted fixed by means of a pin 50. First and second outlet ports 51, 52 opened at the lower surface of the reservoir 47 communicate respectively with first and second replenishing ports 53, 54 which open at the top of the cylinder body 25 for replenishing the operating fluid to the first and second cylinder chambers 42, 43. The first replenishing port 53 opens to a shoulder portion of the first master piston 35 positioned at an inoperative position and is to be closed by means of a seal element 36 when the first master piston 35 is slid. When the first master piston 35 is slid, the space between the first master piston 35 and the forward end of the master cylinder 25a is kept opened to the reservoir 47 through a hole 55 formed in the cylinder body 25. The seal element 36 is held on a shoulder portion of the first master piston 35 to be slid bodily with the same. The second replenishing port 54 communicates with a groove which is radially provided at a surface abutting on the seal element 34 of the ring member 33. This groove in turn communicates with a replenishing hole 56 which is radially provided in an annular portion of the second master piston 38, when the same is positioned at an inoperative position. The communication of the groove with the replenishing hole 56 is shut off when the second master piston 36 is slid to depart from the inoperative position.

In order to connect the output rod 78 of the brake booster 2 with the piston rod 37 of the cylinder device 3 by a joint means 87 prior to connecting the brake booster device 2 with the master cylinder device 3, the cap 86 of the master cylinder device 3 is unscrewed to be removed, and the first master piston 35 is pushed rearward with a suitable rod-like tool inserted from the forward end opening of the master cylinder 25a into the same. Thus, the rear end portion of the piston rod 37 is pushed rearward out of the rear end surface of the cylinder body 25. In this state, first and second links 89, 90 pivotally connected by means of a pin 88 are screwed respectively into the forward end of the output rod 78 and the rear end of the piston rod 37 to be secured thereto, so that the output rod 78 and the piston rod 37 are connected by the joint means 87 to be tiltable or bendable relative to each other.

For connecting the brake booster device 2 with the master cylinder device 3, the forward end surface 13a of the front shell 13 is brought into abutting engagement with the rear surface of the flange portion 25d of the cylinder body 25 as a cylindrical portion 13b projecting forward from the forward end surface 13a is inserted into the opening hole 25c with a seal element 85 interposed therebetween. The male screw portion 26b of each tie rod 26 is made pass through a connecting hole provided on the flange portion 25d for screw engagement with the nut 27 thereon. Thereafter, the forward end opening of the master cylinder 25a is closed by the cap 86.

The operation of the first embodiment as constructed above will be described hereinafter. When the brake pedal 12 is stepped on thereby to pull the input rod 10 toward right as viewed in FIG. 1, the annular ring 82 engaged in the connecting member 62 is moved toward right against the compression springs 75, 76 as it compresses the reaction member 81. This causes the valve member 74 of the control valve 70 to depart from the second valve seat 65 of the atmospheric valve member 63. Thus, the atmosphere in the passenger room is flown into the variable pressure chamber 18 through the second valve seat 65 and the communication grooves 57b. This causes the pressure difference to occur between the variable pressure chamber 18 and the constant pressure chamber 17, whereby the diaphragm 16, the plate 19 and the piston 20 are moved rearward against the resilient force of the return spring 61.

With the rearward movement of the piston 20, the output rod 78 is retracted as urged by the reaction member 81, and the piston rod 37 is then pulled by the output rod 78 through the joint means 87. Thus, the first master piston 35 in the master cylinder 25a is moved rearward together with the piston rod 37 thereby to close the first replenishing port 53 with the seal element 36. After the first replenishing port 53 is closed, the rearward movement of the first master piston 35 causes the operating fluid to be pressurized within the first cylinder chamber 42, and the pressurized brake fluid is supplied to the first brake system (not shown) through the port 45.

The output rod 78 and the piston rod 37 are connected respectively to the first and second rinks 89, 90 which are joined pivotably about the pin 87. Thus, even when the output rod 78 swings or tilts as the piston 20 is retracted, such swing or tilting motion can be prevented from being transmitted to the piston rod 37, so that the first master piston 35 can be moved back and forth smoothly without scraping or damaging the master cylinder 25, i.e., the internal surface guiding the first master piston 3. It is to be noted that since the fitting portions of the pin 87 into the first and second rinks 89, 90 have respective slight plays or clearances, the first and second links 89, 90 can be slightly bent to the axial direction of the first and second rinks 89, 90.

Since the brake fluid (i.e., operating fluid) in the first cylinder chamber 42 is increased with the rearward movement of the first master piston 35, the second master piston 38 is moved rearward as it compresses the compression spring 49. Thus, the replenishing hole 56 is shut off with the seal element 34 to be disconnected from the second replenishing port 54. After the second replenishing port 54 is closed, the rearward movement of the second master piston 38 causes the operating fluid (i.e., brake fluid) to be pressurized within the second cylinder chamber 43, and the pressurized operating fluid is supplied to the second brake system (not shown) through the port 46. The second master piston 38 is balanced at the position where it makes the first and second cylinder chambers 42, 43 have the same pressure.

On the other hand, the piston 20 is moved rearward in dependence on the pressure difference across the diaphragm 16 and at the same time, moves the first master piston 35 through the output rod 78 as it resiliently deforms the reaction member 81. The valve member 74 of the control valve member 70 is retracted relative to the atmospheric valve member 63. Therefore, when the piston 20 pulls the output rod 78 with the operating force which coincides with the stepping force on the brake pedal 12, the valve member 74 of the control valve member 70 is brought into contact with the second valve seat 65 thereby to cut off the communication of the variable pressure chamber 18 with the atmosphere, so that the hydraulic brake pressure can be sustained at a magnitude as desired. At this time, the force with which the brake pedal is stepped on is transmitted through the input rod 10 to the connecting member 62 and then, from the annular ring 82 of the same to the reaction member 81. Therefore, the reaction member 81 is elastically deformed in dependence on the pedal stepping force, so that the driver can feel the reaction force.

When the brake pedal 12 is released, the elastic restoration capability of the reaction member 81 causes the connecting member 62 move ahead of the piston 20 thereby to separate the valve member 74 of the control valve member 70 from the first valve seat 59. Thus, the negative pressure in the constant pressure chamber 17 is led to the variable pressure chamber 18 through the radial holes 60, the first valve seat 59 and the communication grooves 57b to make zero the pressure difference between the variable pressure chamber 18 and the constant pressure chamber 17. Therefore, the piston 20, the plate 19 and the diaphragm 16 are moved forward by the resilient force of the return spring 61 to be returned to the original position. With the forward movement of the piston 20, on the contrary, the first and second master pistons 35, 38 of the master cylinder 25 are returned to their respective original or inoperative positions, whereby the first and second cylinder chambers 42, 43 of the master cylinder 25 are made again open to the reservoir 47.

(Second Embodiment)

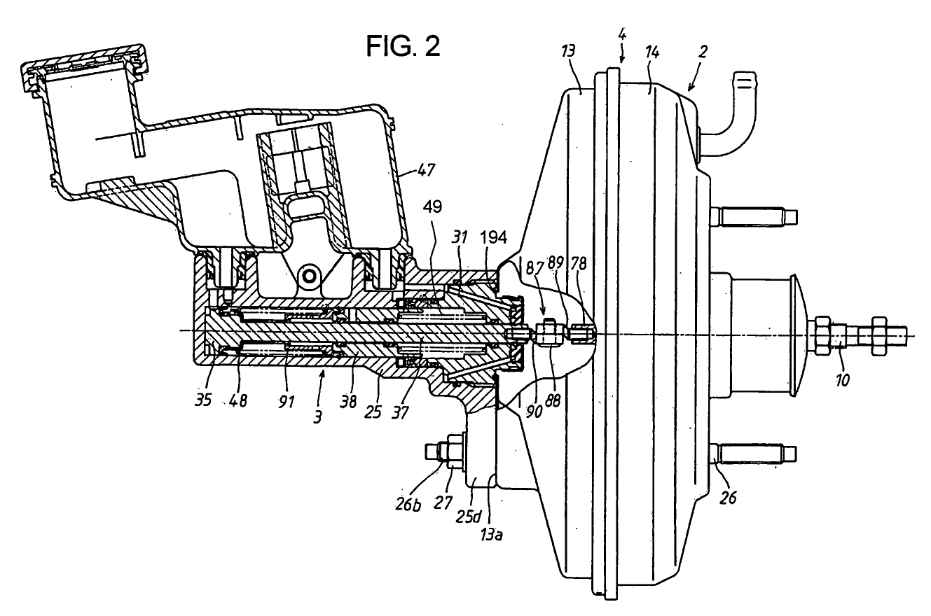

Subsequently, the second embodiment according to the present invention will be described with reference to FIG. 2. In the aforementioned first embodiment, the rear end portion of the piston rod 37 of the master cylinder device 3 is located ahead of the rear end surface of the cylinder body 25. In the second embodiment, on the contrary, the forward end of the output rod 78 of the brake booster device 2 is located behind the forward end surface 13a of the front shell 13. For this reason, in advance of connecting the brake booster device 2 with the master cylinder device 3, the output rod 78 is pulled ahead of the forward end surface 13a of the front shell 13, in which state the output rod 78 and the piston rod 37 are connected by the joint means 87. Upon completion of such connection, the forward end surface 13a of the front shell 13 is brought into abutting engagement with the rear end surface of the flange portion 25d of the cylinder body 25 with a seal element 194 interposed therebetween. Then, the forward end male screw portion 26b of each tie rod 26 made pass through the connecting hole provided at the flange portion 25d, and the nut 27 is screw-engaged with the male screw portion 26b, whereby the brake booster device 2 is connected with the master cylinder device 3.

Further, the compression spring 48 interposed between the first and second master pistons 35, 38 is preliminarily compressed between a pair of spring seats (not numbered) which are accessible to each other with the largest distance therebetween being limited by a telescopic mechanism 91. The preliminary compression force of the compression spring 48 is set larger than that of the compression spring 49 which is interposed between the second master piston 38 and the plug member 31, so that the second master piston 38 when in the inoperative state can be kept stopped at the neutral position. Other constructions than as aforementioned are the same as those in the first embodiment, and therefore, the description therefor are omitted for the sake of brevity because the same reference numerals as used in the first embodiment are put on the same or corresponding parts in this second embodiment.

In the foregoing first embodiment, the first master piston 35 is pushed rearward by inserting a suitable rod-like tool from the forward end opening of the master cylinder 25a, so that the rear end portion of the piston rod 37 is pushed rearward out of the rear end surface of the cylinder body 25. However, in a modified form of the first embodiment, the master cylinder 25a may be of the type having a forward end closed, and therefore, the piston rod 37 may be pulled from the rear end opening to bring the rear end portion thereof into a position behind of the rear end surface of the cylinder body 25, in which state the output rod 78 and the piston rod 37 may be connected by the joint means 87.

(Other Forms of Joint Means)

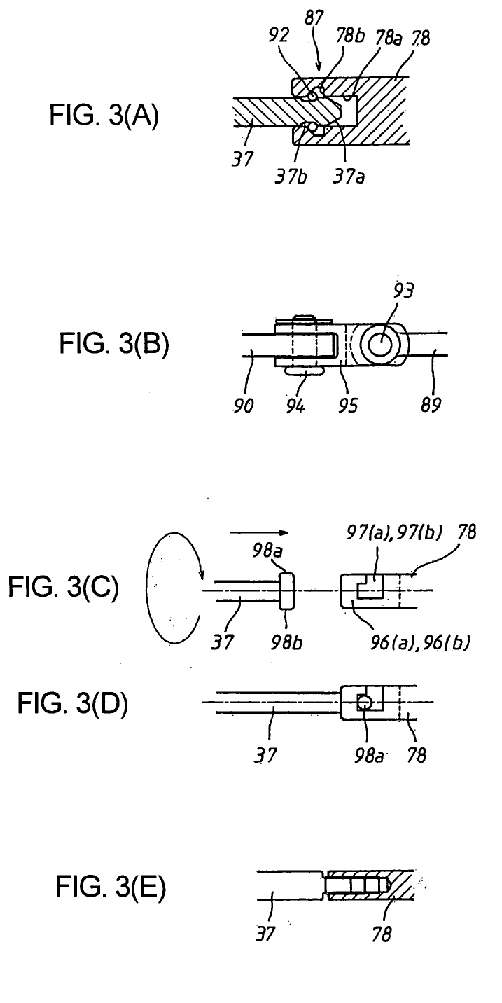

Description will be made hereafter as to other modified forms of the joint means 87 for connecting the output rod 78 with the piston rod 37. One of such other modified forms may be constituted as shown in FIG. 3(A), wherein a connecting hole 78a is formed from the forward end surface of the output rod 78, and an annular groove 78b is formed on the internal surface of the connecting hole 78a. The rear end portion of the piston rod 37 is formed with a taper portion 37a and an annular groove 37b, and a C-ring 92 is fit in the annular groove 37b. For connecting the brake booster device 2 with the master cylinder device 3, the forward end surface 13a of the front shell 13 is brought into abutting engagement with the rear end surface of the flange portion 25d of the cylinder body 25. At this time, the rear end portion of the piston rod 37 is inserted into the connecting hole 78a as it is guided along the taper portion 37a. Thus, the C-ring 92 is contracted along a taper surface provided at the entrance of the connecting hole 78a thereby to be entered into the same. The C-ring 92 expands in alignment with the annular groove 78b and automatically connects the piston rod 37 with the output rod 78 with itself being engaged with both taper wall surfaces of the annular grooves 78b, 37b.

Further, as shown in FIG. 3(B), another modified form of the joint means 87 may be constituted by a universal joint of the type that the first and second links 89, 90 screw-secured to the end surfaces of the output rod 78 and the piston rod 37 are joined to a third link 95 through pins 93, 94 extending at the angular difference of 90 degrees.

Still another modified form of the joint means 87 may be constituted as shown in FIGS. 3(C) and 3(D). That is, a pair of connecting protrusions 96a, 96b are provided in the form of a folk, and a pair of L-letter shape connecting grooves 97a, 97b are formed to open respectively at opposite lateral surfaces of the connecting protrusions 96a, 96b and to be bent forward. Then, engaging portions 98a, 98b which protrude radially outwardly at the rear end surface of the piston rod 37 are fit between the connecting protrusions 96a, 96b and then, the piston rod 37 is turned 90 degrees, so that the engaging portions 98a, 98b are fit in the bent portions of the connecting grooves 97a, 97b, as shown in FIG. 3(D).

A further modified form of the joint means 87 may be of the configuration shown in FIG. 3(E), wherein the output rod 78 and the piston rod 37 are screw-joined between a female screw hole formed at the forward end portion of the output rod 78 and a male screw portion formed at the rear end portion of the piston rod 37.

Finally, various features and many of the attendant advantages in the foregoing embodiments will be summarized as follows:

In the first embodiment typically shown in FIG. 1 for example, since the brake booster device 2 is connected with the master cylinder device 3 by bringing the front shell 13 into abutting engagement with the rear end surface of the cylinder body 25, and since the output rod 78 of the brake booster device 3 is connected by the joint means 87 with the piston rod 37 of the master cylinder 25a, it can be realized to assemble the brake booster device 2 and the master cylinder device 3 independently of each other. Therefore, there can be provided the master cylinder device with the booster device 1 of an input rod pulling type which is easy to assemble and inexpensive to manufacture.

Also in the first embodiment typically shown in FIG. 1 for example, the piston rod 37 is connected by the joint means 87 with the output rod 78 with its rear end portion being located behind the rear end surface of the cylinder body 25. Thereafter, the brake booster device 2 is connected with the master cylinder device 3 by bringing the front shell 13 into abutting engagement with the rear end surface of the cylinder body 25. Thus, the brake booster device 2 and the master cylinder device 3 can be assembled independently of each other before the output rod 78 is connected with the piston rod 37.

Also in the first embodiment typically shown in FIG. 1 for example, the master piston 35 is pulled rearward from the opening which is provided to be closable at the forward end portion of the cylinder body 25 and then, is connected with the output rod 78 with its rear end portion being pushed out behind the rear end surface of the cylinder body 25. Thereafter, the front shell 13 is brought into abutting engagement with the rear end surface of the cylinder body 25 to connect the brake booster device 2 with the master cylinder device 3, and the opening is closed. Since the master piston 35 is pushed from the opening thereby to push out the rear end portion of the piston rod 37 behind the rear end surface of the cylinder body 25, it can be done easily to connect the master piston 35 with the output rod 78.

In the modified form of the foregoing embodiment shown typically in FIG. 3(A), when the front shell 13 is brought into abutting engagement with the rear end surface of the cylinder body 25 to connect the brake booster device 2 with the master cylinder device 3, the output rod 78 of the brake booster device 2 is automatically connected with the piston rod 37 of the master cylinder device 3. Accordingly, the connection of the output rod 78 and the piston rod 37 which are hidden in the respective devices 2, 3 can be done quite easily when the brake booster device 2 is connected with the master cylinder device 3.

In the foregoing embodiments shown in FIGS. 1 and 2 as well as in the modified forms shown in FIGS. 3(B), 3(C) and 3(D), since the output rod 78 of the brake booster device 2 and the piston rod 37 of the master cylinder device 3 are connected so that one of the same is bendable relative to the other, the swing or tilting motion of the output rod 78 can be prevented from being transmitted to the piston rod 37, and therefore, the master piston 35 can be smoothly moved back and forth without scraping or damaging the master cylinder 25a, i.e., the internal surface for guiding the master piston 35.

Obviously, numerous modifications and variations of the present invention are possible in light of the above teachings. It is therefore to be understood that within the scope of the appended claims, the present invention may be practiced otherwise than as specifically described herein.

What is claimed is:

1. A master cylinder device with a booster device of an input rod pulling type wherein:
said booster device is so constructed that a diaphragm is put between a front shell and a rear shell to define a constant pressure chamber and a variable pressure chamber, that a piston connected to said diaphragm incorporates therein a valve mechanism for changing over said variable pressure chamber into communication with said constant pressure chamber or into communication with the atmosphere, and a reaction mechanism for transmitting the movement of said piston to an output rod through a reaction member and for feeding the movement of said piston back to said valve mechanism, and that when said input rod is moved by a brake pedal toward a passenger room, said valve mechanism leads the atmosphere into said variable pressure chamber thereby to retract said piston together with said diaphragm;
said master cylinder device is so constructed that a master piston is inserted into a master cylinder formed in a cylinder body, and that when said piston rod connected to said master piston is pulled toward said passenger room, said master cylinder delivers pressurized brake fluid;
said booster device and said master cylinder device are connected with each other by bringing said front shell into abutting engagement with the rear end surface of said cylinder body; and
said output rod of said booster device and said piston rod of said master cylinder device are connected by joint means with each other.

2. The device as set forth in claim 1, wherein:
said piston rod is connected by said joint means with said output rod, with the rear end portion thereof being positioned behind said rear end surface of said cylinder body; and
after the connection of said piston rod with said output rod, said front shell is brought into abutting engagement with the rear end surface of said cylinder body thereby to connect said booster device with said master cylinder device.

3. The device as set forth in claim 2, wherein:
the forward end portion of said cylinder body is provided with a closable opening which is opened for pushing said master piston rearward thereby to position the rear end portion of said piston rod behind the rear end surface of said cylinder body.

4. The device as set forth in claim 1, wherein:
said joint means is able to automatically connect said output rod with said piston rod when said front shell is brought into abutting engagement with the rear end surface of said cylinder body.

5. The device as set forth in claim 1, wherein:
said joint means connecting said output rod of said booster device with said piston rod of said master cylinder device permits said output rod to be bendable relative to said piston rod.

6. The device as set forth in claim 2, wherein:
said joint means connecting said output rod of said booster device with said piston rod of said master cylinder device permits said output rod to be bendable relative to said piston rod.

7. The device as set forth in claim 3, wherein:
said joint means connecting said output rod of said booster device with said piston rod of said master cylinder device permits said output rod to be bendable relative to said piston rod.
